(19) United States
(12) Patent Application Publication
(10) Pub. No.: US 2026/0105309 A1
(43) Pub. Date: Apr. 16, 2026

(54) METHOD FOR MODEL TRAINING AND SYSTEM THEREOF

(71) Applicant: Samsung Electronics Co., Ltd., Suwon-si (KR)

(72) Inventors: Hao WU, XiAn (CN); Yuqi ZHANG, XiAn (CN)

(73) Assignee: Samsung Electronics Co., Ltd., Suwon-si (KR)

(21) Appl. No.: 19/087,998

(22) Filed: Mar. 24, 2025

(30) Foreign Application Priority Data
Oct. 12, 2024 (CN) 202411425990.3

(51) Int. Cl. G06N 3/084; G06N 3/10

(52) U.S. Cl. CPC G06N 3/084; G06N 3/10

(57) ABSTRACT

The present disclosure provides a method for model training and a system thereof. A method for training a deep learning model may include: grouping, by a graphics processing unit (GPU), parameters for each layer of the deep learning model; offloading, by the GPU, the grouped parameters into a plurality of storage devices, respectively, wherein each of the storage devices stores a group of parameters for each of the layers; performing, by the GPU, training of the deep learning model in parallel with the plurality of storage devices.

### CROSS-REFERENCE TO RELATED APPLICATION

This application claims priority under 35 U.S.C. § 119 to Chinese Patent Application No. 202411425990.3, filed Oct. 12, 2024, the entire contents of which are incorporated herein by reference.

### BACKGROUND

### Technical Field

Embodiments of the present disclosure relates to a field of artificial intelligence, and specifically to a method for model training and a system thereof.

### Background Art

With the development of Artificial Intelligence (AI) technology, models become larger and larger to meet the performance requirements set for the models. For example, large deep learning models (such as general pre-trained transformers (e.g., GPT-X (chatGPT))) have billions or even trillions of parameters generated by numerous layers and complex structures. During model training, large deep learning models require hundreds of Graphics Processing Units (GPUs) to store model parameters such as model weights, gradients, optimizer parameters, etc., and to perform a large number of forward propagation (FP) and backward propagation (BP) operations. For example, a deep learning model with 1 trillion parameters requires at least 20 TB of memory to store all the parameters needed for training, which means a large number of GPUs are needed to guarantee training within operational tolerances. Additionally, as the bandwidth between the GPUs and the memory is often less than the speed at which the GPUs process data, limitations in the GPUs accessing the data stored in the memory commonly creates bottlenecks in the data processing during training. Therefore, GPU memory has become a major bottleneck in the training of large deep learning models.

### SUMMARY

Embodiments of the present disclosure provide a method for model training and a system thereof configured to solve some or all of the above problems.

According to a first aspect of the present disclosure, there is provided a method for training a deep learning model, the method includes: grouping, by a graphics processing unit (GPU), parameters for each of the layers of the deep learning model into a set of parameter groups; offloading, by the GPU, the set of parameter groups to a plurality of storage devices by storing each parameter group of the set of parameter groups to a corresponding storage device of the plurality of storage devices; training, by the GPU, the deep learning model in parallel with the plurality of storage devices.

Thereby, the present disclosure achieves parallel operation by grouping and offloading the parameters for each layer of the model to the plurality of storage devices, thereby avoiding the problem of increased cost of training time due to the need to wait for the parameters to be read from the storage devices for model training in the GPU.

In some embodiments, the parameters include weights of the deep learning model; each storage device of the plurality of storage devices includes a dynamic random access memory (DRAM) and NANDs configured to store the weights of the deep learning model; and the training, by the GPU, of the deep learning model in parallel with the plurality of storage devices includes: loading, by the GPU, weights of an (i+1)^{th} layer of the deep learning model from the DRAMs into a memory of the GPU while performing a forward propagation of an i^{th} layer of the deep learning model, wherein i is a positive integer, and prefetching, by the plurality of storage devices, weights of an (i+2)^{th} layer of the deep learning model from NANDs of the plurality of storage devices into the DRAMs.

Thereby, the present disclosure improves the reading speeds between the GPU and the storage devices by reading the weights in parallel and prefetching the weights in parallel, thereby avoiding training delays.

In some embodiments, the parameters include gradients of the deep learning model; and the training, by the GPU, of the deep learning model in parallel with the plurality of storage devices includes: grouping, for each of the layers, the gradients of the deep learning model into a set of gradient groups, and writing each gradient group of the set of gradient groups into a corresponding NAND of the NANDs, while performing backward propagation of the deep learning model.

Thereby, the present disclosure improves the writing speeds between the GPU and the storage devices by writing the gradients in parallel, thereby avoiding training delays.

In some embodiments, the training, by the GPU, of the deep learning model in parallel with the plurality of storage devices includes: updating, by field programmable gate arrays (FPGAs) in the plurality of storage devices, the weights of the deep learning model.

Thereby, the present disclosure accelerates the computation by updating the weights in parallel, thereby avoiding training delays.

In some embodiments, the updating the weights of the deep learning model by the FPGAs in the plurality of storage devices in parallel includes: performing the updating of the weights of the deep learning model in a data parallel manner and in a pipeline parallel manner in the FPGA in each of the storage devices.

Thereby, the present disclosure accelerates the computation by updating the weights in parallel at multiple scales, thereby avoiding training delays.

In some embodiments, the method further includes: respectively storing currently updated weights into another device by the plurality of storage devices while performing the updating of the weights of the deep learning model; deleting, by the plurality of storage devices, previously stored weights in the plurality of storage devices and storing the weights in the other device into the plurality of storage devices after the updating of the weights is completed.

By storing the updated weights to another storage space and retaining the previous weights as a backup, the present disclosure not only avoids the problem of having to wait for the weights in the storage devices to be updated and prefetched in the FP of the first layer of the next iteration, but also avoids the problem of the parameters being unable to be recovered due to the occurrence of training accidents.

In some embodiments, the plurality of storage devices include memory-semantic solid state drives (MS SSDs).

The present disclosure employs the MS SSDs to enable not only parameter prefetching, but also fast read and write. In addition, the MS SSD introduces an FPGA chip suitable for near data processing of offloaded parameters (e.g., weight updating) to avoid frequent data replication.

According to a second aspect of the present disclosure, there is provided a system for training a deep learning model, the system includes: a controller; a graphics processing unit (GPU); and a plurality of storage devices, wherein the controller is configured to cause the GPU to group parameters for each of the layers of the deep learning model into a set of parameter groups; offload the set of parameter groups to the plurality of storage devices by storing each parameter group of the set of parameter groups to a corresponding storage device of the plurality of storage devices; and train the deep learning model in parallel with the plurality of storage devices.

In some embodiments, the parameters include weights for the deep learning model. each of the plurality of storage devices include a dynamic random access memory (DRAM) and NANDs configured to store the weights for the deep learning model; and the controller is configured to: cause the GPU to load weights of an (i+1)^{th} layer of the deep learning model from the DRAMs into a memory of the GPU while performing a forward propagation of an i^{th} layer of the deep learning model, wherein i is a positive integer; and cause the plurality of storage devices to prefetch weights of an (i+2)^{th} layer of the deep learning model from NANDs into the DRAMs.

In some embodiments, the parameters include gradients for the deep learning model; and the controller is configured to cause the GPU to: group, for each of the layers, the gradients of the deep learning model into a set of gradient groups; and write each gradient group of the set of gradient groups into a corresponding NAND of the NANDs while performing backward propagation of the deep learning model.

In some embodiments, the controller is configured to: cause field programmable gate arrays (FPGAs) in the plurality of storage devices to perform updating of the weights of the deep learning model in parallel.

In some embodiments, the controller is configured to enable the plurality of storage devices to: cause the FPGA in each of the storage devices to update the weights of the deep learning model in a data parallel manner and in a pipeline parallel manner.

Alternatively, the controller is configured to enable the plurality of storage devices to: respectively store currently updated weights into another device while performing the updating of the weights of the deep learning model; delete previously stored weights in the plurality of storage devices and store the weights in the other device into the plurality of storage devices, respectively, after the updating of the weights is completed.

In some embodiments, the plurality of storage devices include memory-semantic solid state drives (MS SSDs).

According to a third aspect of the present disclosure, there is provided a computer readable storage medium storing a computer program, which when executed by a processor, causes an apparatus including the processor to perform the method described above.

It should be understood that the general description above and the detailed description below are illustrative and explanatory only and do not limit the present disclosure.

### BRIEF DESCRIPTION OF THE DRAWINGS

The accompanying drawings herein, which are incorporated into and form a part of the specification, illustrate embodiments consistent with the present disclosure and are used in conjunction with the specification to explain the principles of the present disclosure and do not constitute an undue limitation of the present disclosure.

FIG. 1 illustrates a schematic diagram of a training process of a deep neural network (DNN);

FIG. 2 illustrates a schematic diagram of memory consumption in a GPU during training of a DNN;

FIG. 3 illustrates a schematic diagram of performing model training in a GPU and an MS SSD according to at least one embodiment of the present disclosure;

FIG. 4 illustrates a schematic diagram of a structure of a MS SSD and a process of prefetching and updating weights according to at least one embodiment of the present disclosure;

FIG. 5 is a schematic diagram of a layer-based grouping strategy according to at least one embodiment of the present disclosure;

FIG. 6 illustrates an example of transferring parameters from a plurality of MS SSDs to a GPU according to at least one embodiment of the present disclosure;

FIG. 7 illustrates a schematic diagram of performing model training by a plurality of MS SSDs in parallel according to at least one embodiment of the present disclosure;

FIG. 8 illustrates a schematic diagram of a data parallel mechanism and a pipeline parallel mechanism according to at least one embodiment of the present disclosure;

FIG. 9 is a schematic diagram of a backup-based weight transfer strategy of at least one embodiment of the present disclosure;

FIG. 10 is a flowchart of a method for model training according to at least one embodiment of the present disclosure;

FIG. 11 is a flowchart of a forward propagation process according to at least one embodiment of the present disclosure;

FIG. 12 is a flowchart of a backward propagation process according to at least one embodiment of the present disclosure;

FIG. 13 is a block diagram of a system for model training according to at least one embodiment of the present disclosure;

FIG. 14 is a schematic diagram of a system to which a storage device is applied, according to at least one embodiment;

FIG. 15 is a block diagram of a host storage system according to at least one embodiment; and

FIG. 16 is a diagram of a data center to which a memory device is applied, according to at least one embodiment.

### DETAILED DESCRIPTION

In order to enable a person of ordinary skill in the art to better understand technical solutions of the present disclosure, the technical solutions in the embodiments of the present disclosure will be described clearly and completely in the following, in conjunction with the accompanying drawings.

It is noted that terms “first”, “second” and the like in the specification and claims of the present disclosure and the above accompanying drawings are used for distinguishing similar objects, and need not to be used for describing a particular order or sequence. It should be understood that data so used may be interchanged, where appropriate, so that the embodiments of the present disclosure described herein may be implemented in an order other than those illustrated or described herein. The embodiments described in the following embodiments do not represent all embodiments consistent with the present disclosure. Rather, they are only examples of apparatuses and methods consistent with some aspects of the present disclosure as detailed in the appended claims.

It will be understood that the operations discussed in the present disclosure may be performed by a unit or units configured to process at least one function and/or to perform at least one operation, which may be implemented in and/or enabled by processing circuitry such as hardware, software, or a combination of hardware and software. For example, unless otherwise indicated, the processing circuitry may include, but is not limited to, a central processing unit (CPU), an application processor (AP), an arithmetic logic unit (ALU), a graphic processing unit (GPU), a digital signal processor, a microcomputer, a field programmable gate array (FPGA), a System-on-Chip (SoC) a programmable logic unit, a microprocessor, a neural processing unit (NPU), an application-specific integrated circuit (ASIC), etc.

It is noted herein that a phrase “at least one of several items” as it appears in the present disclosure is intended to encompass three parallel cases of “any one of the several items”, “a combination of any number of the several items” , and “all of the several items”. For example, “including at least one of A and B” includes the following three parallel cases: (1) including A; (2) including B; and (3) including A and B. Another example is “performing at least one of step 1 and step 2”, which represents the following three parallel cases: (1) performing step 1; (2) performing step 2; and (3) performing step 1 and step 2.

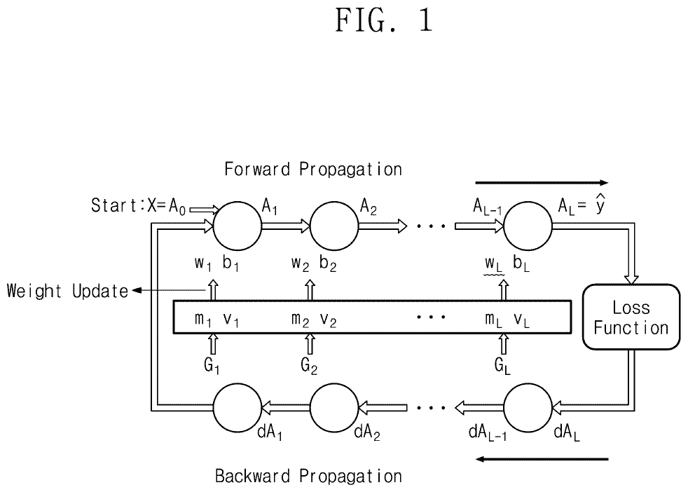

Artificial intelligence models, for example, Deep Neural Network (DNN) models consist of many interconnected layers in which samples are propagated. A training process of a deep neural network may be a process of repeated matrix computations. FIG. 1 illustrates a schematic diagram of a training process of a DNN. As shown in FIG. 1, in forward propagation, an activation function value (AL in FIG. 1, wherein L denotes a Lth layer of the model) of a current layer is calculated by multiplying an activation function value AL-1 of a previous layer with a weight (WL in FIG. 1) of the current layer, and this calculation is performed layer by layer. In addition, a bias (bL in FIG. 1) between expected values and actual values is calculated. In backward propagation, a loss is propagated in a backward order, and a gradient (GL in FIG. 1) is generated and weight updating is performed using a momentum and a variance (mL and vL in FIG. 1) of an optimizer.

As illustrated in FIG. 1, the training process of the model is orderly and predictable, which provides opportunities for memory offloading. For example, training parameters (such as activation function values, weights, gradients, momentums, variances, a combination thereof, and/or the like) in a GPU may be offloaded elsewhere (e.g., a DRAM or a storage), and may be passed back to the GPU when the offloaded parameters are needed for computation. Additionally, an orderly and predictable process facilitates prefetching and makes the GPU insensitive to memory offloading.

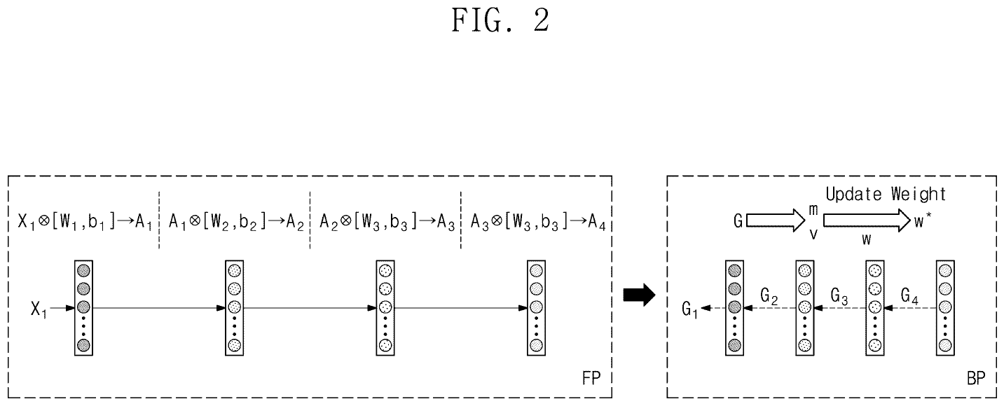

FIG. 2 illustrates a schematic diagram of memory consumption in a GPU during training of a deep neural network.

In Forward Propagation (FP), weights and biases (W and b in FIG. 2, such as W1 denoting a weight of a first layer of the model and b1 denoting a bias of the first layer of the model) and activation function values (A in FIG. 2, such as A1 denoting an activation function value of the first layer of the model) are stored as 16-bit floating-point numbers, which guarantees a high throughput of a GPU core. In the present disclosure, a weight and bias of floating-point precision 16 may be represented as a weight 16 and an activation function value of floating-point precision 16 may be represented as an activation function value 16 (activation 16).

In Backward Propagation (BP), gradients (G in FIG. 2, such as G1 denoting a gradient of the first layer of the model) of floating-point precision 16 are computed by derivatives of the activation function values 16. In the present disclosure, a gradient of floating-point precision 16 may be represented as a gradient 16. Combined with the gradients 16, momentums and variances (m and v in FIG. 2, such as m1 and v1 denoting a momentum and a variance of the first layer of the model) of optimizers are used to update weights (W* in FIG. 2), which are stored as 32-bit floating-point numbers. In the present disclosure, a momentum, a variance and a weight of floating-point precision 32 are denoted as a “momentum 32”, “a variance 32”, and “a weight 32”, respectively.

Generally, a neural network model during training includes weights 16, activation function values 16, gradients 16, momentums 32, variances 32, and weights 32, which may consume a large amount of GPU memory.

As the size of large deep learning models increases, a ratio of a model size to AI hardware (e.g., GPU) memory is up to 100 times, or even 1,000 times, which means that training cost of the large deep learning models is huge, and model reconstruction is complex and difficult. To solve this problem, there exist two main offloading methods:

First, ZeRO-Offload is a method to offload data and computation from a GPU to a CPU for reducing GPU memory usage of a deep learning model during training.

Specifically, weights 32 and optimizer parameters are offloaded to host memory, while activation function values are not offloaded, as there exists an activation checkpointing technique to reduce memory occupied by most activation function values.

Weight updating and float2half computation are offloaded to the CPU, allowing the weight updating and the float2half computation to be performed by the CPU. Computations on forward propagation and backward propagation are performed by the GPU.

Second, ZeRO-Cache is a method to offload data from a GPU to a storage device for reducing GPU memory usage of a deep learning model during training.

Specifically, weights 32 and optimizer parameters are offloaded to an SSD, and weights 16 and gradients 16 are offloaded to a host memory (e.g., RAM.). A CPU performs computation of weight updating by prefetching corresponding weights from the SSD. Computations on forward propagation and backward propagation are performed by the GPU using the weights 16 perfected from the RAM.

For the above offloading method, there are several problems:
1. The cost of the RAM and the CPU is high. Large deep learning models have a large number of parameters. Existing schemes offload parameters to the host memory (RAM) and offload computations on weight updating to the CPU. However, large deep learning models (e.g., GPT-4) may be tens or even hundreds of terabytes in size during training, which requires a lot of RAM and is very expensive. Offloading the computation to the CPU may also result in the CPU not having enough cores to perform common operations in training, such as data processing and data augmentation, so the CPU will become a new bottleneck.
2. The cost of communication and replication is high. ZeRO-Cache offloads some model parameters to the RAM and the SSD, and communication and data replication between the SSD, the RAM and the GPU is very complicated, so data read/write IO operations will become a new bottleneck.
3. Parameters have high volatility. Since the parameters of the above offloading methods will be inconsistent during the updating process, latest parameters at the time of training cannot be recovered when an accident occurs.

In order to solve the GPU memory problem as well as to overcome the drawbacks in the above solutions, the present disclosure proposes a method for model training that offloads components of deep learning model training from the GPU to a memory-semantic solid state drive (MS SSD) to reduce GPU memory consumption, and since parameters of the deep learning model are offloaded to the MS SSD instead of the RAM, the computation of weight updating is performed by a FPGA of the MS SSD instead of the CPU, the MS SSD is cheap, and thus the cost of the MS SSD is significantly lower than the cost of the RAM and the CPU, thereby reducing the cost of model training.

The models of the present disclosure may be deep neural network (DNN) models, and may also be other models that include multiple layers, such as, a convolutional neural network (CNN) model, a recurrent neural network (RNN) model, a generative adversarial network (GAN) model, a long-short-term memory network (LSTM) model, a residual network (ResNet, e.g., ResNet-1922) model, an attention mechanism model, a Transformer model, a GPT model, a visual geometry group (VGG) model, a OverFeat model, a dense network (DenseNet, e.g., DenseNet-1001) model, a GoogLeNet model, and an AlexNet model, etc. ; however, the present disclosure is not limited to these examples, and the models may also be other types of artificial intelligence models.

The components of deep learning model training by the GPU may involve computations (such as forward propagation (FP), backward propagation (BP), weight update, and float32 to float 16 conversion) and parameters (such as weights 16, activation function values 16, gradients 16, optimizer parameters (momentums 32, variances 32, and weights 32)).

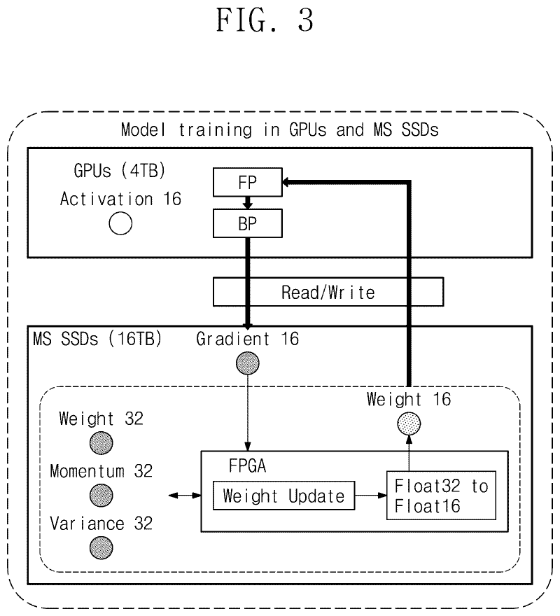

FIG. 3 illustrates a schematic diagram of performing model training in a GPU and an MS SSD according to at least one embodiment of the present disclosure.

Referring to FIG. 3, optimizer parameters may be offloaded since the optimizer parameters occupy a large proportion and are only used for weight updating but they are not needed in FP and BP. In addition, a weight 16 of a certain layer is only needed when training to that layer, and thus the weight 16 may also be offloaded. The above offloaded parameters are used for weight updating, and relative to FP and BP computations, the weight update having lower complexity and simple computations of float32 to float16 may also be offloaded to a Field Programmable Gate Array (FPGA) in the MS SSD.

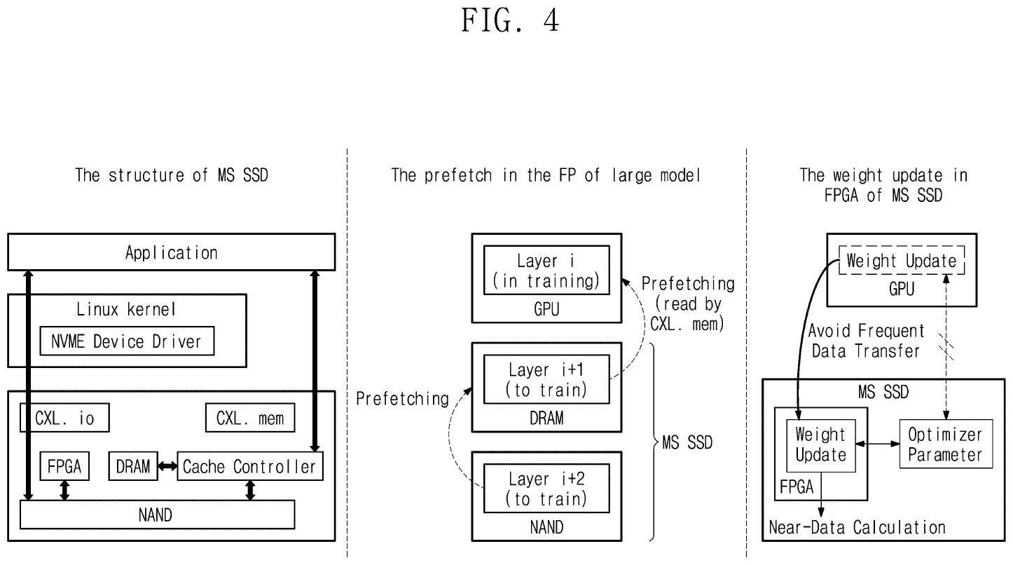

FIG. 4 illustrates a schematic diagram of a structure of a MS SSD and a process of prefetching and updating weights according to at least one embodiment of the present disclosure.

A GPU may communicate with the MS SSD via a Compute Express Link (CXL) protocol. A high-performance mode of the MS SSD includes functions of: 1) data prefetching (hardware caching): prefetching is to preload data from a NAND into a DRAM; 2) supporting for dual-mode access: performing non-volatile memory (NVMe) read/write via CXL. io, and performing memory read by accessing a Logical Block Address (LBA) via CXL. mem.

Since the training process of the deep learning model is orderly and predictable, a prefetch interface of the MS SSD may prefetch parameters for a next training into the DRAM in advance, and load the parameters into the GPU quickly via CXL. mem. Referring to FIG. 4, when performing forward propagation of an ith layer (Layer i) of a deep learning model, weights of an (i+1)^{th} layer (Layer i+1) of the deep learning model are loaded from the DRAM of the MS SSD to the memory of the GPU by the GPU via CXL. mem, where i is a positive integer, and weights of an (i+2)^{th} layer (Layer i+2) of the deep learning model is prefetched from the NAND into the DRAM by the MS SSD.

CXL.mem reads from DRAM at up to 25 GB/s and CXL.io writes faster.

An FPGA chip is introduced in the MS SSD for near data processing and computation, suitable for near data processing of offloaded parameters (e.g., weight updating) to avoid frequent data replication (e.g., if the weight updating is still performed in the GPU, the optimizer parameters would need to be transferred frequently between the GPU and the MS SSD, resulting in an IO bottleneck). The present disclosure therefore offloads the parameters and computations of the deep learning model to the MS SSD.

The present disclosure considers that the model training may be delayed if the weights 16 and the gradients 16 are not transferred in a timely manner, and therefore proposes a layer-based group offloading strategy of grouping and offloading parameters of each layer of the model to a plurality of MS SSDs to realize parallel transfer to solve the IO bottleneck between the GPU and the MS SSD.

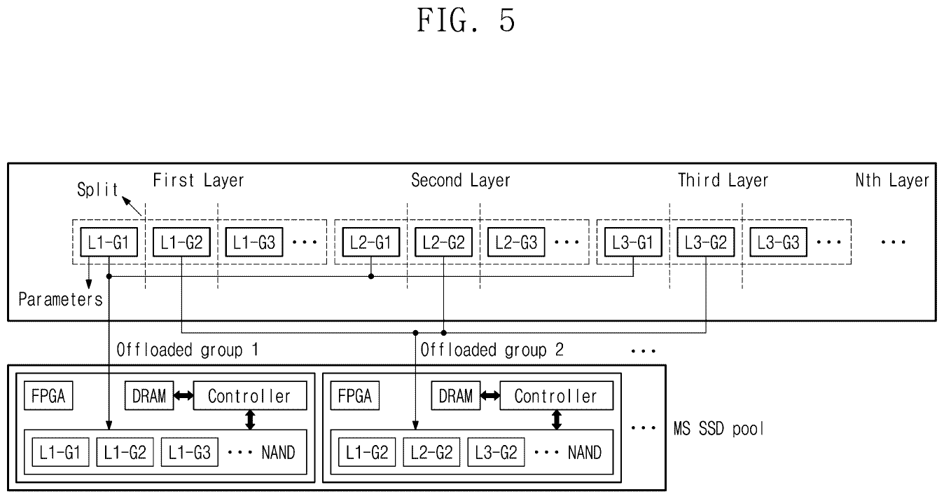

FIG. 5 is a schematic diagram of a layer-based grouping strategy according to at least one embodiment of the present disclosure.

Due to the slow IO between the GPU and the MS SSD, training in the GPU may be forced to wait to read parameters from the MS SSD. This training delay leads to an increase in time cost. To overcome this problem, the present disclosure designs the layer-based grouping strategy.

Referring to FIG. 5, parameters of each layer of the deep learning model are evenly divided into multiple groups of parameters (or parameters groups), such as L1-G1 denoting a first group of parameters of a first layer of the model, L1-G2 denoting a second group of parameters of the first layer of the model, . . . , LN-G1 denoting a first group of parameters of an N^{th} layer of the model, and so on. The multiple groups of parameters may also be collectively referred to as a set of parameter groups. In at least some embodiments, the grouping may be based on, e.g., the type of operation and/or the results/inferences of the operation. For example, in at least one embodiment, a group may correspond to distinguishing an object from a background, another group may correspond to categorizing the object, another group may correspond to identifying and/or executing an action based on the categorization, etc. Additionally, at least some of the groups may include groups corresponding to parameters directed towards a sub-problem; for example, a group corresponding to categorizing an object may be divided based on groups of items to be identified and/or categorizations for distinguishing the objects from each other. Alternatively, in at least one embodiment, a group may correspond to parameters directed towards identifying patterns in historical data, another group may correspond to parameters directed towards identifying current conditions, another group may correspond to predicting future conditions, another group may correspond to confirming the accuracy of the predictions, another group may correspond to identifying and/or executing an action based on the categorization, etc. However, these are only examples, and the parameters may be divided based on alternative criteria for training of the DNN. Additionally, at least some of the parameters may be shared be some and/or all of the groups, but each of the groups will have fewer parameters than the total number of parameters.

An MS SSD pool is constructed to store parameters. The grouped parameters of each layer may be offloaded to each MS SSD in the MS SSD pool respectively. For example, a first group of parameters of a first layer, a first group of parameters of a second layer, . . . a first group of parameters of an Nth layer of the model are offloaded into a NAND of a first MS SSD, a second group of parameters of the first layer, a second group of parameters of the second layer, . . . a second group of parameters of the Nth layer of the model are offloaded into a NAND of a second MS SSD, and so on. As such, each of the MS DSS may store the corresponding group (e.g., groups related to the same/or similar type of operation and/or the same/or similar type inferences) for each of the layers. In this way, the aforementioned IO operations (transfer of weights 16 and gradients 16) and weight updating operations may be performed in parallel, thereby avoiding training delay.

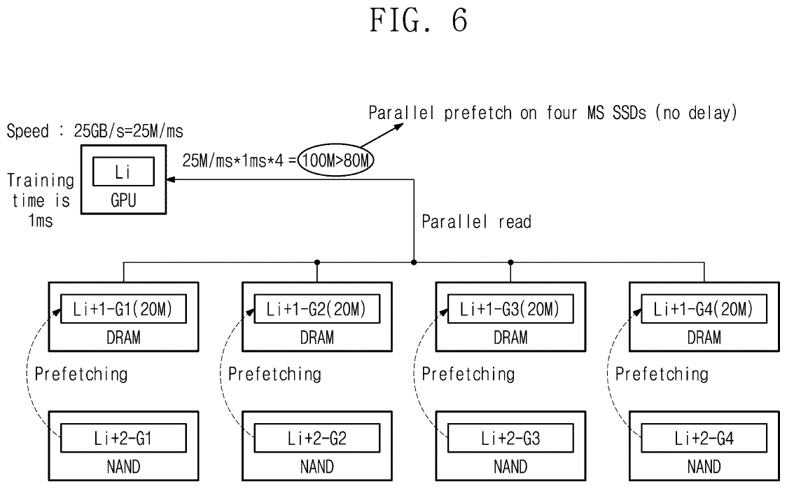

FIG. 6 illustrates an example of transferring parameters from a plurality of MS SSDs to a GPU according to at least one embodiment of the present disclosure.

It is assumed that a size of weights 16 in a Kth layer is 80M, FP in a (K−1)th layer is about 1 millisecond (ms), and a speed of CXL.mem is 25 gigabytes per second (25 G/s=25M/ms). In the case of conventional FP, only 25 Megabytes (25M/ms*1ms) of parameters of the Kth layer may be read at the FP of the (K−1) layer, which delays the FP of the Kth layer. Referring to FIG. 5, according to at least one embodiment of the present disclosure, it is assumed that four MS SSDs is used for parallel IO, the weights 16 of the Kth layer may be fully read at the FP of the (K−1)th layer (25M* 4=100M>80M) and there is no training delay.

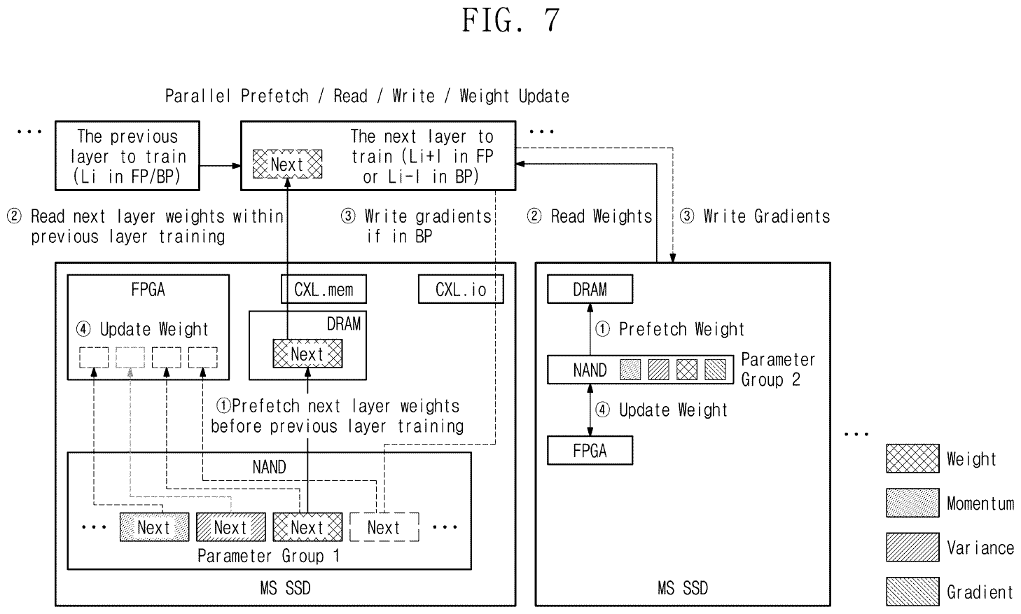

FIG. 7 illustrates a schematic diagram of performing model training by a plurality of MS SSDs in parallel according to at least one embodiment of the present disclosure. In FIG. 7, “next” in different pattern boxes indicates different parameters of a next layer.

Referring to FIG. 7, in each MS SSD, weights of a next layer are prefetched into the DRAM before a previous layer is trained, so as to realize parallel prefetching.

In the previous layer of training, the weights of the next layer in the DRAMs of multiple MS SSDs are read into the GPU via CXL.mem in parallel to realize parallel reading.

If in a BP process, gradients after the BP will be grouped and written to the NAND of each MS SSD via CXL. io to realize parallel writing.

The weight updating of multiple parameter groups (e.g., Parameter Group 1, Parameter Group 2, etc.) are performed in parallel on multiple FPGAs in multiple MS SSDs to realize parallel weight updating. This is the first parallelization of weight updating to accelerate the computation.

Considering that the computation of weight updating in the FPGAs of the MS SSDs is slower than that in the GPU, and untimely weight updating will delay training, the present disclosure designs a multi-scale parallel weight updating method, i.e., a combination of data parallelism and pipeline parallelism is used by the FPGA in each MS SSD to accelerate the computation of weight updating.

By using parallel prefetch/read/write/near data computation in the MS SSDs, the computation of the FPGAs in the MS SSDs may be accelerated.

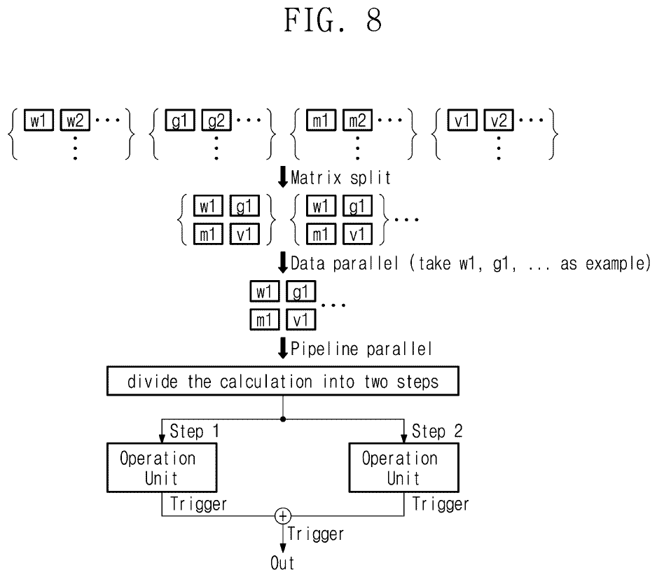

Two computational mechanisms are provided in each FPGA (e.g., a data parallel mechanism and a pipeline parallel mechanism). FIG. 8 illustrates a schematic diagram of a data parallel mechanism and a pipeline parallel mechanism according to at least one embodiment of the present disclosure.

Referring to FIG. 8, in the data parallel mechanism, data is divided into a plurality of groups/blocks and same operations are performed by corresponding processing units. In the pipeline parallel mechanism, operations are divided into a plurality of steps and the steps are performed by operation units in parallel.

According to at least one embodiment of the present disclosure, weight updating is performed in parallel using multiple scales. Specifically, in a data parallel operation, all model parameters are divided into a plurality of blocks, and then computation of weight updating is performed in each block using an ADAM optimization algorithm. In a pipelined parallel operation, the computation of weight updating is divided into a plurality of steps in each block. The plurality of steps may be computed in parallel by a plurality of operation units and then combined to accomplish the weight updating. The above data parallel operation and pipeline parallel operation are performed in each FPGA of each MS SSD, thereby realizing parallel weight updating of multiple MS SSDs. The computation of the ADAM algorithm in the FPGA of the MS SSD is accelerated by employing the multi-scale parallel weight updating method of data parallelism and pipeline parallelism by multiple MS SSDs.

With this approach, the computation of offloaded weight updating will be greatly accelerated, so that this computational offloading does not hamper training and the data transfer bottleneck (such as frequent transfer of optimizer parameters) is avoided by the near data computation.

According to the present disclosure, considering that there is a waiting time for weight updating (especially offloading to the MS SSDs for execution) between a previous BP and a next FP, the present disclosure designs a backup-based weight transfer strategy, whereby a weight backup of a previous version is used for next FP in order to avoid waiting for weight updating.

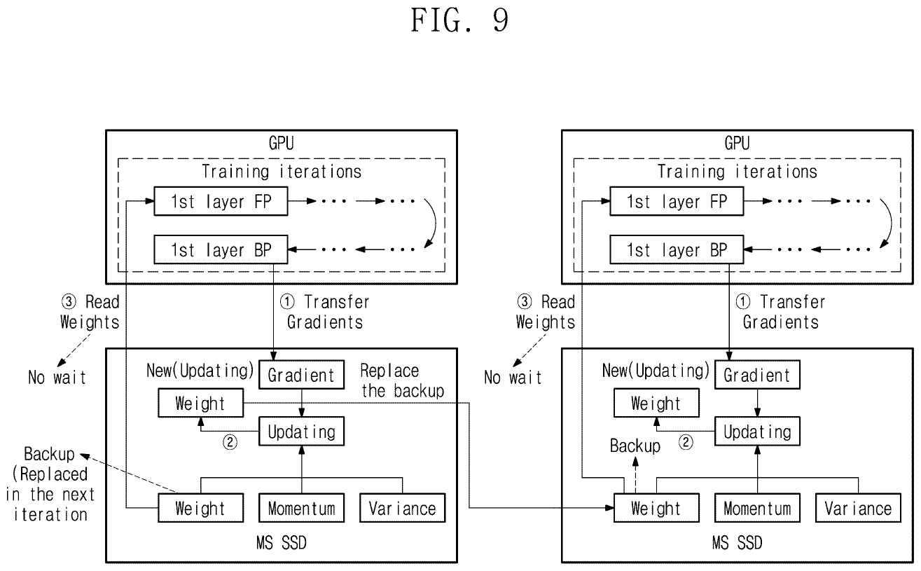

FIG. 9 is a schematic diagram of a backup-based weight transfer strategy of at least one embodiment of the present disclosure. This strategy is used when a gradient has a negligible effect on model training.

Referring to FIG. 9, the strategy stores new updated weights to another storage instead of overwriting them, so that old weights may be kept as a backup. The old weights may be read during iterative training without waiting for weight updating to complete. When the weight updating is completed, old weights are replaced by new weights (e.g., the new weights become old backup weights). This strategy is suitable for a common case where a difference in weights between two training iterations is small.

In addition, optimizer parameters are offloaded into NANDs of MS SSDs (which are non-volatile), so this strategy may be used for accidental recovery. During the weight updating process, the new weights are not fully acquired, so the backup weights may be used for accidental recovery. For example, the backup weights are always consistent because the backup weights may be replaced only after all new weights are acquired. If training stops unexpectedly and training recovery is required, the backup weights may be used to initialize the model. The backup weights are read from the MS SSDs to the GPU and the model training continues.

This strategy stores two copies of weights, allowing for immediate recovery of the failed model in the event of a training accident.

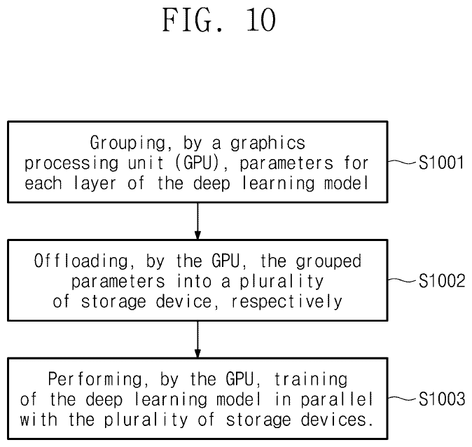

FIG. 10 is a flowchart of a method for model training according to at least one embodiment of the present disclosure.

Referring to FIG. 10, at step S1001, parameters for each layer of a deep learning model are grouped by a graphics processing unit (GPU).

At step S1002, the grouped parameters are offloaded by the GPU into a plurality of storage devices, respectively, wherein each of the storage devices stores a group of parameters for each layer. The plurality of storage devices may include memory-semantic solid state drives (MS SSDs). By offloading most of the parameters in the training of the deep learning model, GPU memory consumption may be greatly reduced.

At step S1003, training of the deep learning model is performed by the GPU in parallel with the plurality of storage devices.

Weights of an (i+1)^{th} layer of the deep learning model may be loaded by the GPU from dynamic random access memories (DRAMs) of the plurality of storage devices into a memory of the GPU when performing forward propagation of an i^{th} layer of the deep learning model, wherein i is a positive integer. Weights of an (i+2)^{th} layer of the deep learning model may be prefetched by the plurality of storage devices from NANDs of the plurality of storage devices into the DRAMs.

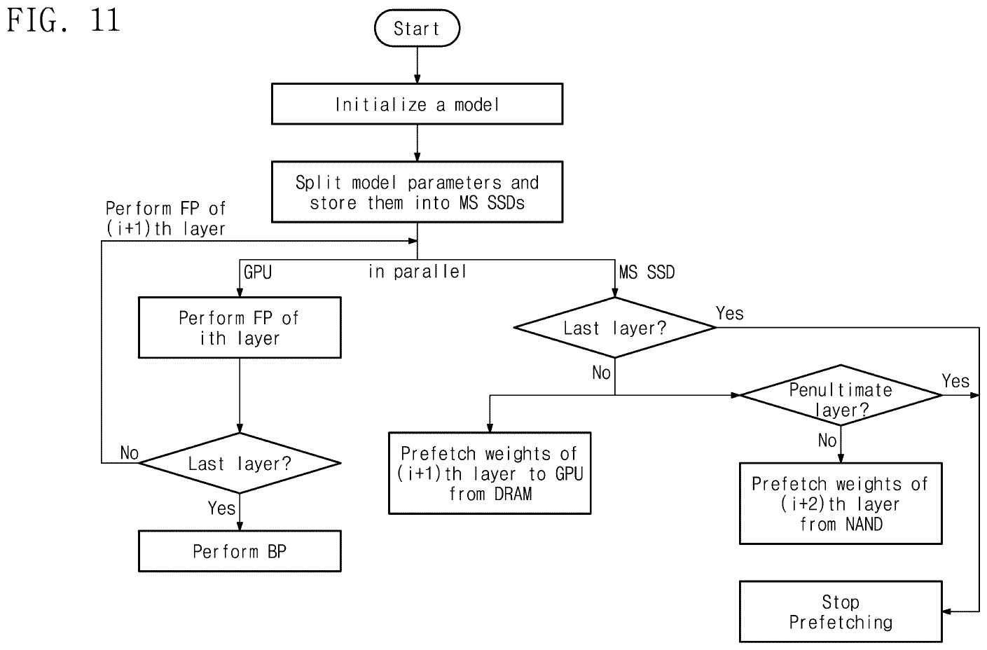

FIG. 11 is a flowchart of a forward propagation process according to at least one embodiment of the present disclosure.

Referring to FIG. 11, at the beginning of model training after model initialization, model parameters may be split and the split parameters may be offloaded and stored into a plurality of MS SSDs, by using a layer-based group offloading strategy. The GPU performs model training in parallel with the plurality of MS SSDs.

A forward propagation operation may be performed layer by layer in the GPU. After the GPU performs forward propagation of an i^{th} layer, the GPU may determine whether the i^{th} layer is the last layer. When the i^{th} layer is determined to not be the last layer, the GPU may continue to perform forward propagation of a next layer (e.g., an (i+1)^{th} layer). When the i^{th} layer is the last layer, the GPU may perform the backward propagation.

The MS SSD may determine whether the i^{th} layer is the last layer, and if the MS SSD determines the i^{th} layer is the last layer, the MS SSD stops a prefetching operation, and if the i^{th} layer is not the last layer, the MS SSD may determine whether the i^{th} layer is the penultimate layer and prefetch weights of the next layer (e.g., the (i+1)^{th} layer) from a DRAM into the GPU for the GPU to perform the forward propagation of the next layer. If it is the penultimate layer, the MS SSD stops the prefetching operation, and if it is not the penultimate layer, the MS SSD prefetches weights of an i+2^{th} layer from a NAND into the DRAM.

When performing backward propagation of the deep learning model, gradients for each layer may be grouped by the GPU and the grouped gradients may be written into the NANDs of the plurality of storage devices, respectively.

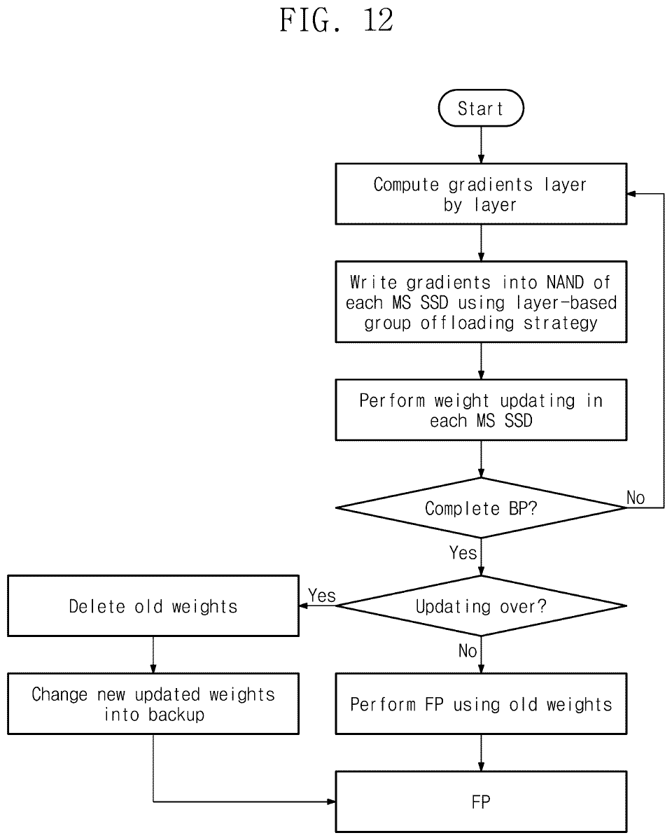

FIG. 12 is a flowchart of a backward propagation process according to at least one embodiment of the present disclosure.

Referring to FIG. 12, a backward propagation operation may be performed in a GPU. Gradients may be computed layer by layer and written into a NAND of each MS SSD using a layer-based group offloading strategy for weight updating.

In each MS SSD, the weight updating may be performed by a FPGA.

Whether the backward propagation is completed is determined, and if so, whether the weight updating is completed is determined, and if not, gradients are continued to be computed.

If the weight updating is completed, previously stored old weights may be deleted and the updated new weights may be stored in the NAND as a backup for forward propagation. If the weight updating is not completed, forward propagation may be performed using the old weights.

The weight updating of the deep learning model may be performed by field programmable gate arrays (FPGs) in the plurality of storage devices in parallel.

The present disclosure performs parallel prefetching/reading/writing/weight updating based on multiple MS SSDs, thereby avoiding IO bottlenecks and training delays.

In the FPGA in each storage device, the weight updating of the deep learning model may be performed in a data parallel manner and in a pipeline parallel manner.

The present disclosure offloads near data computation (weight updating) to the MS SSD to avoid data transfer bottlenecks, and employs multi-scale parallel weight updating to accelerate the near data computation and keep up with the training speed of the GPU.

When performing the weight updating of the deep learning model, currently updated weights may be stored by the plurality of storage devices into another device, respectively. The other device may be a storage space in the MS SSD that is different from the NAND, and/or another storage devices that may be (or is) communicatively connected to the MS SSD. Upon completion of the weight updating, previously stored weights in the plurality of storage devices may be deleted by the plurality of storage devices and the weights in the other device may be stored in the plurality of storage devices accordingly, respectively.

The present disclosure utilizes backup-based weight transfer to avoid waiting for weight updating before the next FP, and the weight backup may also be applicable for training crash recovery.

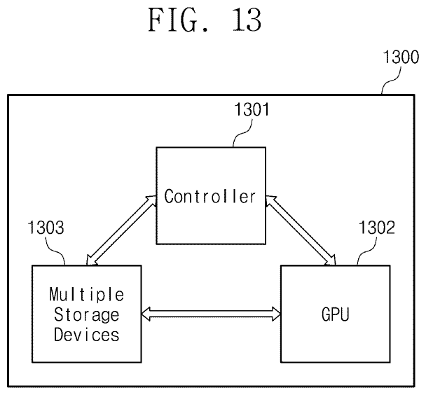

FIG. 13 is a block diagram of a system for model training according to at least one embodiment of the present disclosure.

Referring to FIG. 13, a system 1300 for model training may include a controller 1301, a GPU 1302, and a plurality of storage devices 1303.

The controller 1301 may be implemented by a host. The storage device 1303 may include a dynamic random access memory (DRAM) and a flash NAND and perform training of a model in the GPU. The storage device 1303 may be a Memory-Semantics Solid State Drive (MS SSD).

In the following example embodiments, the storage device is illustrated as an example of an MS SSD, however, it should be understood that the present disclosure is not limited thereto, e.g., the storage device may also be any storage device that provides a hardware cache (e.g., DRAM).

The controller 1301 may control (e.g., enable, cause, facilitate, instruct, and/or provide instructions enabling and/or initiating) the GPU 1302 to group parameters for each layer of a deep learning model, control the GPU 1302 to offload the grouped parameters into the plurality of storage devices 1303, respectively, wherein each of the storage devices 1303 stores a group of parameters for each of the layers, and control the GPU 1302 to perform training of the deep learning model in parallel with the plurality of storage devices 1303.

When performing forward propagation of an i^{th} layer of the deep learning model, the controller 1301 may control the GPU 1302 to load weights of an (i+1)^{th} of the deep learning model from dynamic random access memories (DRAMs) of the plurality of storage devices 1303 into a memory of the GPU 1302, where i is a positive integer, and control the plurality of storage devices 1303 to prefetch weights of an (i+2)^{th} layer of the deep learning model from NANDs of the plurality of storage devices into the DRAMs.

When performing backward propagation of the deep learning model, the controller 1301 may control the GPU 1302 to group gradients for each layer and write the grouped gradients into the NANDs of the plurality of storage devices 1303, respectively.

The controller 1301 may control (e.g., enable, cause, facilitate, instruct, and/or provide instructions enabling and/or initiating) field programmable gate arrays (FPGAs) in the plurality of storage devices 1303 to perform updating of weights of the deep learning model in parallel.

In the FPGA in each of the storage devices 1303, the controller 1301 may control the FPGA to perform the updating of the weights of the deep learning model in a data parallel manner and in a pipeline parallel manner.

When performing the updating of the weights of the deep learning model, the controller 1301 may control the plurality of storage devices 1303 to store currently updated weights into another device, respectively, and when the updating of the weights is completed, the controller 1301 may control the plurality of storage devices 1303 to, respectively, delete previously stored weights in the plurality of storage devices 1303 and store the weights in the other device into the plurality of storage devices 1303 accordingly.

Large deep learning models are widely used in fields such as semantic analysis and computer vision, which consume a large amount of hardware memory. The strategies and algorithms of the present disclosure may be directly used to offload parameters of large deep learning models to the MS SSDs. Thereby, the MS SSDs may be used to reduce GPU memory requirements and training costs.

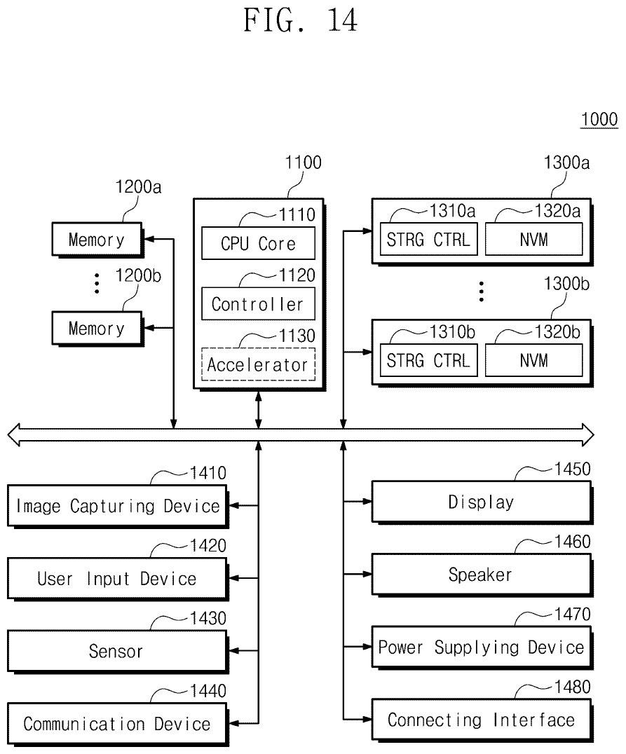

FIG. 14 is a diagram of a system 1000 to which a storage device is applied, according to at least one embodiment.

The system 1000 of FIG. 14 may be, for example, a mobile system, such as a portable communication terminal (e.g., a mobile phone), a smartphone, a tablet personal computer (PC), a wearable device, a healthcare device, or an Internet of things (IOT) device. However, the system 1000 of FIG. 14 is not limited thereto and may be, for example, a PC, a laptop computer, a server, a media player, or an automotive device (e.g., a navigation device).

Referring to FIG. 14, the system 1000 may include a main processor 1100, memories (e.g., 1200a and 1200b), and storage devices (e.g., 1300a and 1300b). In addition, the system 1000 may include at least one of an image capturing device 1410, a user input device 1420, a sensor 1430, a communication device 1440, a display 1450, a speaker 1460, a power supplying device 1470, and a connecting interface 1480.

The main processor 1100 may control all operations of the system 1000, for example, operations of other components included in the system 1000. The main processor 1100 may be implemented as, for example, a general-purpose processor, a dedicated processor, a graphics processor or an application processor.

The main processor 1100 may include at least one CPU core 1110 and a controller 1120 configured to control the memories 1200a and 1200b and/or the storage devices 1300a and 1300b. In some embodiments, the main processor 1100 may further include an accelerator 1130, which is a dedicated circuit for a high-speed data operation, such as an artificial intelligence (AI) data operation. The accelerator 1130 may include, for example, a graphics processing unit (GPU), a neural processing unit (NPU), and/or a data processing unit (DPU) and be implemented as a chip that is physically separate from the other components of the main processor 1100.

The memories 1200a and 1200b may be used as main memory devices of the system 1000. Although each of the memories 1200a and 1200b may include a volatile memory, such as static random access memory (SRAM) and/or dynamic RAM (DRAM), according to embodiments, each of the memories 1200a and 1200b may include non-volatile memory, such as a flash memory, phase-change RAM (PRAM) and/or resistive RAM (RRAM). The memories 1200a and 1200b may be implemented in the same package as the main processor 1100.

The storage devices 1300a and 1300b may serve as non-volatile storage devices configured to store data regardless of whether power is supplied thereto, and have larger storage capacity than the memories 1200a and 1200b. The storage devices 1300a and 1300b may respectively include storage controllers (STRG CTRL) 1310a and 1310b and NVM (Non-Volatile Memory)s 1320a and 1320b configured to store data under the control of the storage controllers 1310a and 1310b. Although the NVMs 1320a and 1320b may include V-NAND flash memories having a two-dimensional (2D) structure or a three-dimensional (3D) structure, the NVMs 1320a and 1320b may include other types of NVMs, such as PRAM and/or RRAM.

The storage devices 1300a and 1300b may be physically separated from the main processor 1100 and included in the system 1000 or implemented in the same package as the main processor 1100. The storage devices 1300a and 1300b may be solid-state devices (SSDs) or memory cards and be removably combined with other components of the system 100 through an interface, such as the connecting interface 1480 that will be further described below. The storage devices 1300a and 1300b may be devices to which a standard protocol, such as a universal flash storage (UFS), an embedded multi-media card (eMMC), or a non-volatile memory express (NVMe), is applied, but the storage devices 1300a and 1300b are not limited thereto.

The image capturing device 1410 may be configured to capture still images and/or moving images. The image capturing device 1410 may include, for example, a camera, a camcorder, and/or a webcam.

The user input device 1420 may receive various types of data input by a user of the system 1000 and include, for example, a touch pad, a keypad, a keyboard, a mouse, and/or a microphone.

The sensor 1430 may detect various types of physical quantities, which may be obtained from the outside of the system 1000, and convert the detected physical quantities into electric signals. The sensor 1430 may include, for example, a temperature sensor, a pressure sensor, an illuminance sensor, a position sensor, an acceleration sensor, a biosensor, and/or a gyroscope sensor.

The communication device 1440 may transmit and receive signals between other devices outside the system 1000 according to various communication protocols. The communication device 1440 may, for example, include an antenna, a transceiver, and/or a modem.

The display 1450 and the speaker 1460 may serve as output devices configured to respectively output visual information and auditory information to the user of the system 1000.

The power supplying device 1470 may appropriately convert power supplied from a battery embedded in the system 1000 and/or an external power source, and supply the converted power to each of components of the system 1000.

The connecting interface 1480 may provide connection between the system 1000 and an external device, which is connected to the system 1000 and capable of transmitting and receiving data to and from the system 1000. The connecting interface 1480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

According to the embodiments of the disclosure, a system (e.g., 1000), to which a storage apparatus is applied, is provided, the system includes a main processor (e.g., 1100); a memory (e.g., 1200a and 1200b); and the storage apparatus (e.g., 1300a and 1300b), wherein the main processor and the storage apparatus is configured to perform the method for model training as described above.

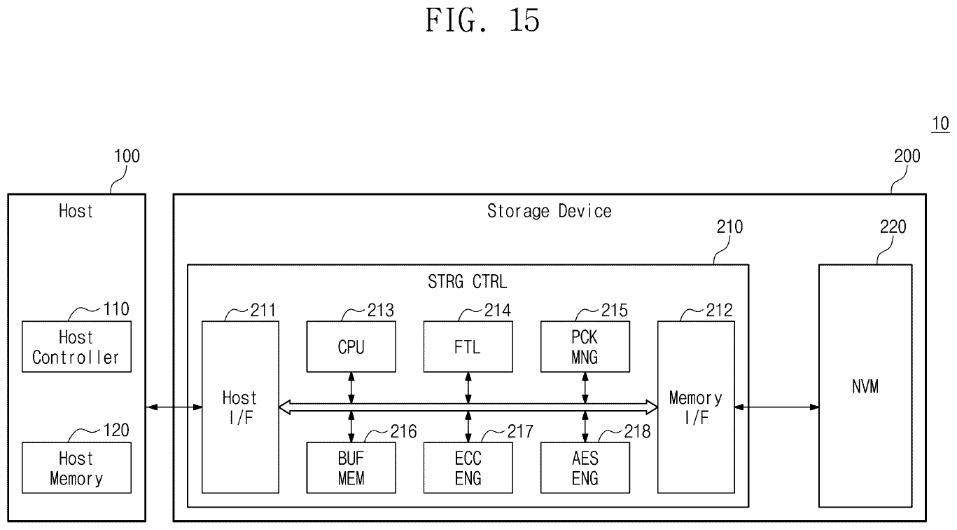

FIG. 15 is a block diagram of a host storage system 10 according to at least one embodiment.

The host storage system 10 may include a host 100 and a storage device 200. The storage device 200 may include a storage controller 210 and an NVM 220. According to at least one embodiment, the host 100 may include a host controller 110 and a host memory 120. The host memory 120 may serve as a buffer memory configured to temporarily store data to be transmitted to the storage device 200 or data received from the storage device 200.

The storage device 200 may include storage media configured to store data in response to requests from the host 100. As an example, the storage device 200 may include at least one of an SSD, an embedded memory, and a removable external memory. When the storage device 200 is an SSD, the storage device 200 may be a device that conforms to an NVMe standard. When the storage device 200 is an embedded memory or an external memory, the storage device 200 may be a device that conforms to a UFS standard or an eMMC standard. Each of the host 100 and the storage device 200 may generate a packet according to an adopted standard protocol and transmit the packet.

When the NVM 220 of the storage device 200 includes a flash memory, the flash memory may include a 2D NAND memory array or a 3D (or vertical) NAND (VNAND) memory array. As another example, the storage device 200 may include various other kinds of NVMs. For example, the storage device 200 may include magnetic RAM (MRAM), spin-transfer torque MRAM, conductive bridging RAM (CBRAM), ferroelectric RAM (FRAM), PRAM, RRAM, and various other kinds of memories.

According to at least one embodiment, the host controller 110 and the host memory 120 may be implemented as separate semiconductor chips. Alternatively, in some embodiments, the host controller 110 and the host memory 120 may be integrated in the same semiconductor chip. As an example, the host controller 110 may be any one of a plurality of devices included in an application processor (AP). The AP may be implemented as, for example, a System on Chip (SoC). Further, the host memory 120 may be an embedded memory included in the AP or memory device located outside the AP.

The host controller 110 may manage an operation of storing data (e.g., write data) of a buffer region of the host memory 120 in the NVM 220 or an operation of storing data (e.g., read data) of the NVM 220 in the buffer region.

The storage controller 210 may include a host interface 211, a memory interface 212, and a CPU 213, a flash translation layer (FTL) 214, a packet manager 215, a buffer memory 216, an error correction code (ECC) engine 217, and an advanced encryption standard (AES) engine 218. The storage controllers 210 may further include a working memory in which the FTL 214 is loaded. The CPU 213 may execute the FTL 214 to control data write and read operations on the NVM 220.

The host interface 211 may transmit and receive packets to and from the host 100. A packet transmitted from the host 100 to the host interface 211 may include a command or data to be written to the NVM 220. A packet transmitted from the host interface 211 to the host 100 may include a response to the command or data read from the NVM 220. The memory interface 212 may transmit data to be written to the NVM 220 to the NVM 220 or receive data read from the NVM 220. The memory interface 212 may be configured to comply with a standard protocol, such as Toggle or open NAND flash interface (ONFI).

The FTL 214 may perform various functions, such as an address mapping operation, a wear-leveling operation, and a garbage collection operation. The address mapping operation may be an operation of converting a logical address received from the host 100 into a physical address used to actually store data in the NVM 220. The wear-leveling operation may be a technique for preventing or reducing excessive deterioration of a specific block by allowing blocks of the NVM 220 to be uniformly used. As an example, the wear-leveling operation may be implemented using a firmware technique that balances erase counts of physical blocks. The garbage collection operation may be a technique for ensuring usable capacity in the NVM 220 by erasing an existing block after copying valid data of the existing block to a new block.

The packet manager 215 may generate a packet according to a protocol of an interface, which consents to the host 100, or parse various types of information from the packet received from the host 100. In addition, the buffer memory 216 may temporarily store data to be written to the NVM 220 or data to be read from the NVM 220. Although the buffer memory 216 may be a component included in the storage controllers 210, in the embodiment, the buffer memory 216 may be set outside the storage controllers 210.

The ECC engine 217 may perform error detection and correction operations on read data read from the NVM 220. For example, the ECC engine 217 may generate parity bits for write data to be written to the NVM 220, and the generated parity bits may be stored in the NVM 220 together with write data. During the reading of data from the NVM 220, the ECC engine 217 may correct an error in the read data by using the parity bits read from the NVM 220 along with the read data, and output error-corrected read data.

The AES engine 218 may perform at least one of an encryption operation and a decryption operation on data input to the storage controllers 210 by using a symmetric-key algorithm.

According to the embodiments of the disclosure, a host storage system (e.g., 10) is provided, the host storage system includes a host (e.g., 100); and a storage device (200), wherein the storage apparatus is configured to perform the method for model training as described above.

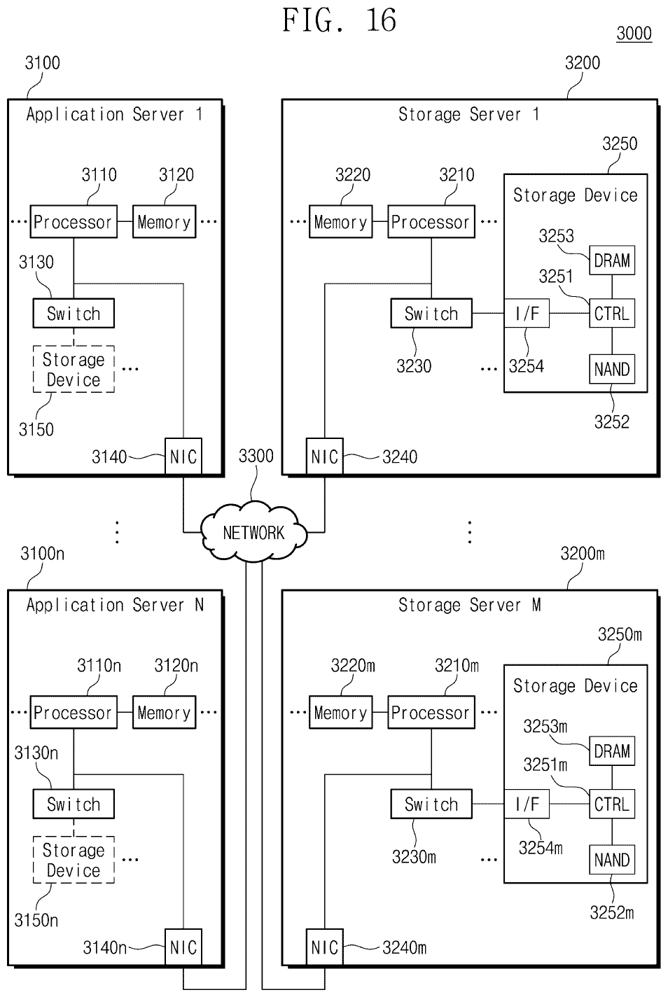

FIG. 16 is a diagram of a data center 3000 to which a memory device is applied, according to at least one example embodiment.

### Platform Portion—Server (Application/Storage)

Referring to FIG. 16, the data center 3000 may be a facility that collects various types of pieces of data and provides services and be referred to as a data storage center. The data center 3000 may be a system for operating a search engine and a database, and may be a computing system used by companies, such as banks, or government agencies. The data center 3000 may include application servers 3100 to 3100n and storage servers 3200 to 3200m, wherein n and m are positive integers. The number of application servers 3100 to 3100n and the number of storage servers 3200 to 3200m may be variously selected according to embodiments. The number of application servers 3100 to 3100n may be different from the number of storage servers 3200 to 3200m.

The application server 3100 or the storage server 3200 may include at least one of processors 3110 and 3210 and memories 3120 and 3220, at least one of switches 3130 to 3130n, at least one of network interface cards (NICs) 3140 to 3140n and 3240 to 3240m, at least one of DRAMs 3253 to 3253m, and at least one of controllers 3251 to 3251m. The storage server 3200 will now be described as an example. The processor 3210 may control all operations of the storage server 3200, access the memory 3220, and execute instructions and/or data loaded in the memory 3220. The memory 3220 may be, for example, a double-data-rate synchronous DRAM (DDR SDRAM), a high-bandwidth memory (HBM), a hybrid memory cube (HMC), a dual in-line memory module (DIMM), Optane DIMM, and/or a non-volatile DIMM (NVMDIMM). In some embodiments, the numbers of processors 3210 and memories 3220 included in the storage server 3200 may be variously selected. In at least one embodiment, the processor 3210 and the memory 3220 may provide a processor-memory pair. In at least one embodiment, the number of processors 3210 may be different from the number of memories 3220. The processor 3210 may include a single-core processor or a multi-core processor. The above description of the storage server 3200 may be similarly applied to the application server 3100. In some embodiments, the application server 3100 may not include a storage device 3150. The storage server 3200 may include at least one storage device 3250. The number of storage devices 3250 included in the storage server 3200 may be variously selected according to embodiments.

### Platform Portion—Network

The application servers 3100 to 3100n may communicate with the storage servers 3200 to 3200m through a network 3300. The network 3300 may be implemented by using a fiber channel (FC) or Ethernet. In this case, the FC may be a medium used for relatively high-speed data transmission and use an optical switch with high performance and high availability. The storage servers 3200 to 3200m may be provided as file storages, block storages, or object storages according to an access method of the network 3300.

In at least one embodiment, the network 3300 may be a storage-dedicated network, such as a storage area network (SAN). For example, the SAN may be an FC-SAN, which uses an FC network and is implemented according to an FC protocol (FCP). As another example, the SAN may be an Internet protocol (IP)-SAN, which uses a transmission control protocol (TCP)/IP network and is implemented according to a SCSI over TCP/IP or Internet SCSI (iSCSI) protocol. In one embodiment, the network 3300 may be a general network, such as a TCP/IP network. For example, the network 3300 may be implemented according to a protocol, such as FC over Ethernet (FCoE), network attached storage (NAS), and NVMe over Fabrics (NVMe-oF).

Hereinafter, the application server 3100 and the storage server 3200 will mainly be described. A description of the application server 3100 may be applied to another application server 3100n, and a description of the storage server 3200 may be applied to another storage server 3200m.

The application server 3100 may store data, which is requested by a user or a client to be stored, in one of the storage servers 3200 to 3200m through the network 3300. Also, the application server 3100 may obtain data, which is requested by the user or the client to be read, from one of the storage servers 3200 to 3200m through the network 3300. For example, the application server 3100 may be implemented as a web server or a database management system (DBMS).

The application server 3100 may access a memory 3120n or a storage device 3150n, which is included in another application server 3100n, through the network 3300. Alternatively, the application server 3100 may access memories 3220 to 3220m or storage devices 3250 to 3250m, which are included in the storage servers 3200 to 3200m, through the network 3300. Thus, the application server 3100 may perform various operations on data stored in application servers 3100 to 3100n and/or the storage servers 3200 to 3200m. For example, the application server 3100 may execute an instruction for moving or copying data between the application servers 3100 to 3100n and/or the storage servers 3200 to 3200m. In this case, the data may be moved from the storage devices 3250 to 3250m of the storage servers 3200 to 3200m to the memories 3120 to 3120n of the application servers 3100 to 3100n directly or through the memories 3220 to 3220m of the storage servers 3200 to 3200m. The data moved through the network 3300 may be data encrypted for security or privacy.

### Organic Relationship—Interface Structure/type

The storage server 3200 will now be described as an example. An interface 3254 may provide physical connection between a processor 3210 and a controller 3251 and a physical connection between a network interface card (NIC) 3240 and the controller 3251. For example, the interface 3254 may be implemented using a direct attached storage (DAS) scheme in which the storage device 3250 is directly connected with a dedicated cable. For example, the interface 3254 may be implemented by using various interface schemes, such as ATA, SATA, e-SATA, an SCSI, SAS, PCI, PCIe, NVMe, IEEE 1394, a USB interface, an SD card interface, an MMC interface, an eMMC interface, a UFS interface, an eUFS interface, and/or a CF card interface.

The storage server 3200 may further include a switch 3230 and the NIC(Network InterConnect) 3240. The switch 3230 may selectively connect the processor 3210 to the storage device 3250 or selectively connect the NIC 3240 to the storage device 3250 under the control of the processor 3210.

In at least one embodiment, the NIC 3240 may include a network interface card and a network adaptor. The NIC 3240 may be connected to the network 3300 by, for example, a wired interface, a wireless interface, a Bluetooth interface, or an optical interface. The NIC 3240 may include an internal memory, a digital signal processor (DSP), and a host bus interface and be connected to the processor 3210 and/or the switch 3230 through the host bus interface. The host bus interface may be implemented as one of the above-described examples of the interface 3254. In at least one embodiment, the NIC 3240 may be integrated with at least one of the processor 3210, the switch 3230, and the storage device 3250.

### Organic Relationship—Interface operation

In the storage servers 3200 to 3200m or the application servers 3100 to 3100n, a processor may transmit a command to storage devices 3150 to 3150n and 3250 to 3250m or the memories 3120 to 3120n and 3220 to 3220m and program or read data. In this case, the data may be data of which an error is corrected by an ECC engine. The data may be data on which a data bus inversion (DBI) operation or a data masking (DM) operation is performed, and may include cyclic redundancy code (CRC) information. The data may be data encrypted for security or privacy.

Storage devices 3150 to 3150n and 3250 to 3250m may transmit a control signal and a command/address signal to NAND flash memory devices 3252 to 3252m in response to a read command received from the processor. Thus, when data is read from the NAND flash memory devices 3252 to 3252m, a read enable (RE) signal may be input as a data output control signal, and thus, the data may be output to a DQ bus. A data strobe signal DQS may be generated using the RE signal. The command and the address signal may be latched in a page buffer depending on a rising edge or falling edge of a write enable (WE) signal.

### Product Portion—SSD Basic Operation

The controller 3251 may control all operations of the storage device 3250. In at least one embodiment, the controller 3251 may include SRAM. The controller 3251 may write data to the NAND flash memory device 3252 in response to a write command or read data from the NAND flash memory device 3252 in response to a read command. For example, the write command and/or the read command may be provided from the processor 3210 of the storage server 3200, the processor 3210m of another storage server 3200m, or the processors 3110 and 3110n of the application servers 3100 and 3100n. DRAM 3253 may temporarily store (or buffer) data to be written to the NAND flash memory device 3252 or data read from the NAND flash memory device 3252. Also, the DRAM 3253 may store metadata. Here, the metadata may be user data or data generated by the controller 3251 to manage the NAND flash memory device 3252. The storage device 3250 may include a secure element (SE) for security or privacy.

According to at least one example embodiment of the disclosure, a data center system (e.g., 3000) is provided, the data center system includes a plurality of application servers (3100 to 3100n); and a plurality of storage servers (e.g., 3200 to 3200m), wherein each storage server includes a storage apparatus, wherein the storage apparatus is configured to perform the method for model training as described above.

As is conventional in the field of the present disclosure, the embodiments are described and illustrated in the accompanying drawings in accordance with functional blocks, units, and/or modules. Those skilled in the art will understand that the blocks, units, and/or modules are physically realized by electronic (or optical) circuits (such as logic circuits, discrete assemblies, microprocessors, hardwired circuits, memory elements, wiring connections, and the like), these circuits may be formed using semiconductor-based manufacturing techniques or other manufacturing techniques. In the case that the blocks, units, and/or modules are implemented by microprocessors or the like, and may be programmed using software (e.g., microcode) to perform the various functions discussed herein, and they may optionally be driven by firmware and/or software. Optionally, each block, unit, and/or module may be implemented by dedicated hardware or implemented as a combination of dedicated hardware that performs some functions and a processor (e.g., one or more programmed microprocessors and associated circuitries) that performs other functions.

According to at least one embodiment of the present disclosure, there is provided a computer program product having instructions stored therein, wherein the instructions, when executed by a processor, implement the method for model training as described above.

According to at least one embodiment of the present disclosure, there is provided an electronic device comprising a processor and a memory storing a computer program, wherein the computer program, when executed by the processor, implements the method for model training as described above.

According to at least one embodiment of the disclosure, a computer-readable storage medium storing a computer program may also be provided, when the computer program is executed, the method for model training according to the embodiments of the present disclosure may be performed. Examples of computer-readable storage media include read-only memory (ROM), random access programmable read-only memory (PROM), electrically erasable programmable read-only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, BLU-RAY or optical disk memory, hard disk drive (HDD), solid state drive (SSD), card-based memory (such as, e.g., multimedia cards, Secure Digital (SD) cards and/or Extreme Digital (XD) cards), magnetic tapes, floppy disks, magneto-optical data storage devices, optical data storage devices, hard disks, solid state disks, and/or any other device, where the any other device is configured to store the computer programs and any associated data, data files, and/or data structures in a non-transitory manner and to provide the computer programs and any associated data, data files, and/or data structures to a processor or computer, so that the processor or computer may execute the computer program. The computer program in the computer readable storage medium may run in an environment deployed in a computer device such as, for example, a terminal, client, host, agent, server, etc. In one example, the computer program and any associated data, data files and/or data structures are distributed on a networked computer system such that the computer program and any associated data, data files and/or data structures are stored, accessed, and executed in a distributed manner by one or more processors or computers.

According to the method for model training and the system thereof according to the example embodiments of the present disclosure, offloading most of the parameters in the training of the large deep learning model may reduce GPU memory consumption, introducing MS SSDs instead of the host RAM to offload the parameters may further reduce the cost; in addition, the layer-based group offloading strategy is proposed for parallel prefetching/reading/writing/weight updating based on multiple MS SSDs to avoid IO bottlenecks and training delays; in addition, the near data computation (weight updating) is offloaded to the MS SSDs to avoid data transfer bottlenecks, and multi-scale parallel weight updating is used to accelerate the near data computation and keep up with the training speed of the GPU; furthermore, the backup-based weight transfer is proposed to avoid waiting for weight updating before the next FP, and the weight backup is also used for recovery of training crash.

While the present disclosure has been particularly shown and described with reference to embodiments thereof, it will be understood by those of ordinary skill in the art that various changes in form and detail may be made therein without departing from the spirit and scope of the present disclosure as defined by the following claims.

What is claimed is:

1. A method for training a deep learning model including a plurality of layers, comprising:
grouping, by a graphics processing unit (GPU), parameters for each of the layers of the deep learning model into a set of parameter groups;
offloading, by the GPU, the set of parameter groups to a plurality of storage devices by storing each parameter group of the set of parameter groups to a corresponding storage device of the plurality of storage devices; and
training, by the GPU, the deep learning model in parallel with the plurality of storage devices.

2. The method according to claim 1, wherein the parameters include weights of the deep learning model;
wherein each storage device of the plurality of storage devices includes a dynamic random access memory (DRAM) and NANDs configured to store the weights of the deep learning model; and
wherein the training, by the GPU, of the deep learning model in parallel with the plurality of storage devices comprises
loading, by the GPU, weights of an (i+1)^{th} layer of the deep learning model from the DRAMs into a memory of the GPU while performing a forward propagation of an i^{th} layer of the deep learning model, wherein i is a positive integer, and
prefetching, by the plurality of storage devices, weights of an (i+2)^{th} layer of the deep learning model from the NANDs into the DRAMs.

3. The method according to claim 1, wherein each of the plurality of storage devices includes NANDS respectively configured to store corresponding parameter groups for each of the layers of the deep learning model;
wherein the parameters include gradients of the deep learning model; and
wherein the training, by the GPU, of the deep learning model in parallel with the plurality of storage devices comprises
grouping, for each of the layers, the gradients of the deep learning model into a set of gradient groups, and
writing each gradient group of the set of gradient groups into a corresponding NAND of the NANDs, while performing backward propagation of the deep learning model.

4. The method according to claim 1, wherein the parameters include weights of the deep learning model; and
wherein the training, by the GPU, of the deep learning model in parallel with the plurality of storage devices comprises updating, by field programmable gate arrays (FPGAs) in the plurality of storage devices, the weights of the deep learning model in parallel.

5. The method according to claim 4, wherein the updating the weights of the deep learning model by the FPGAs in the plurality of storage devices in parallel comprises:
performing the updating of the weights of the deep learning model in a data parallel manner and in a pipeline parallel manner in the FPGA in each of the storage devices.

6. The method according to claim 4, further comprising:
respectively storing currently updated weights into another device by the plurality of storage devices while performing the updating of the weights of the deep learning model;
deleting, by the plurality of storage devices, previously stored weights in the plurality of storage devices; and
storing the weights in the other device into the plurality of storage devices, respectively, after the updating of the weights is completed.

7. The method according to claim 1, wherein the plurality of storage devices comprise memory-semantic solid state drives (MS SSDs).

8. A system for training a deep learning model including a plurality of layers, comprising:
a controller;
a graphics processing unit (GPU); and
a plurality of storage devices,
wherein the controller is configured to cause the GPU to
group parameters for each of the layers of the deep learning model into a set of parameter groups,
offload the set of parameter groups to the plurality of storage devices by storing each parameter group of the set of parameter groups to a corresponding storage device of the plurality of storage devices, and
train the deep learning model in parallel with the plurality of storage devices.

9. The system according to claim 8, wherein the parameters include weights for the deep learning model;
wherein each of the plurality of storage devices include a dynamic random access memory (DRAM) and NANDs configured to store the weights for the deep learning model; and
wherein the controller is configured to,
cause the GPU to load weights of an (i+1)^{th} layer of the deep learning model from the DRAMs into a memory of the GPU while performing a forward propagation of an i^{th} layer of the deep learning model, wherein i is a positive integer, and
cause the plurality of storage devices to prefetch weights of an (i+2)^{th} layer of the deep learning model from the NANDs into the DRAMs.

10. The system according to claim 8, wherein each of the plurality of storage devices includes NANDS respectively configured to store corresponding parameter groups for each of the layers of the deep learning model;
wherein the parameters include gradients for the deep learning model; and
wherein the controller is configured to cause the GPU to
group, for each of the layers, the gradients of the deep learning model into a set of gradient groups, and
write each gradient group of the set of gradient groups into a corresponding NAND of the NANDs while performing backward propagation of the deep learning model.

11. The system according to claim 8, wherein the parameters include weights of the deep learning model; and
the controller is configured to cause field programmable gate arrays (FPGAs) in the plurality of storage devices to perform updating of the weights of the deep learning model in parallel.

12. The system according to claim 11, wherein the controller is configured to
cause the FPGA in each of the storage devices to update the weights of the deep learning model in a data parallel manner and in a pipeline parallel manner.

13. The system according to claim 11, wherein the controller is configured to cause the plurality of storage devises to
respectively store currently updated weights into another device while performing the updating of the weights of the deep learning model;
delete previously stored weights in the plurality of storage devices; and
store the weights in the other device into the plurality of storage devices, respectively, after the updating of the weights is completed.

14. The system according to claim 8, wherein the plurality of storage devices comprise memory-semantic solid state drives (MS SSDs).

15. A computer readable storage medium storing a computer program, which when executed by a processor, causes an apparatus including the processor to perform a method for training a deep learning model including a plurality of layers, wherein the method comprises to:
grouping parameters for each of the layers of the deep learning model
offloading the grouped parameters to a plurality of storage devices such that each of the storage devices stores a corresponding group of the grouped parameters for each of the layers; and
training the deep learning model in parallel with the plurality of storage devices.

16. The computer readable storage medium storing the computer program of claim 15, wherein the parameters include at least one of activation function values, weights, gradients, momentums, variances, or a combination thereof.

17. The computer readable storage medium storing the computer program of claim 15, wherein the parameters include weights of the deep learning model;
wherein the training of the deep learning model in parallel with the plurality of storage devices comprises updating weights of the deep learning model in parallel; and
wherein the method further comprises
respectively storing currently updated weights into another device by the plurality of storage devices while performing the updating of the weights of the deep learning model;
deleting, by the plurality of storage devices, previously stored weights in the plurality of storage devices; and
storing the weights in the other device into the plurality of storage devices, respectively, after the updating of the weights is completed.
